(19) United States
(12) Patent Application Publication
(10) Pub. No.: US 2008/0091771 A1
(43) Pub. Date: Apr. 17, 2008

(54) Visual representations of profiles for community interaction

(75) Inventors: Jeffrey L. Allen, Sammamish, WA (US); Tien-Lok Jonathan Lau, Seattle, WA (US); David Jones, Seattle, WA (US); Daniel Plastina, Sammamish, WA (US); Alan Thomas Shen, Redmond, WA (US); Harris David Thurmond, Austin, TX (US)

Correspondence Address: SENNIGER POWERS LLP (MSFT), ONE METROPOLITAN SQUARE, 16TH FLOOR, ST. LOUIS, MO, 63102, US

(73) Assignee: MICROSOFT CORPORATION, Redmond, WA (US)

(21) Appl. No.: 11/549,489

(22) Filed: Oct. 13, 2006

(51) Int. Cl. G06F 15/16

(52) U.S. Cl. 709/203

(57) ABSTRACT

Members of a media community share content where each member of the community is associated with a profile and a portable media device. A portion of the profile is used to create a media card that includes on or more actionable elements that enable the member to interact with the media community. The media card may be embedded in a memory area of the portable media player and accessible by one or more other members of the media community. Utilizing the tag, a member may create and share playlists with other members of the community. Also, a member of the media community can create a friend list comprising of media cards of other members to interact with the other members associated with the media cards.

### BACKGROUND

Users consume digital media content, such as audio, video, and images, on a variety of devices, including portable media players. Often, users join one or more media communities to share media and discover new media, and to interact with other members of the media community. Media communities are important to members because they provide connections or a sense of belonging with friends, family, favorite artists, new friends made through interactions in the media community, and the like. In addition, media communities often provide recognition of a member's individuality, contributions, and achievements within the media community and provide forums for self-expression concerning the member's opinions, tastes, hopes, etc.

Typically, a user of a portable media player must first sync the portable media player to a personal computing device to share media or discover new media. Furthermore, a personal computing device is needed to manage contacts and interact with existing media communities. Existing systems fail to provide a mechanism that allows the user of a portable media player to directly interact with friends, interact with the media community, share media, and discover new media.

### SUMMARY

Embodiments of the invention overcome one or more deficiencies in the known media communities by allowing a member of a media community to quickly and efficiently interact directly with other members. Portable media players embodying aspects of the invention provide connected entertainment and social networking services that enable media community members to directly interact with one another, discover and share media, and the like. For example, aspects of the invention permit users of such media player devices to browse among friends and other community members, discover new content by drilling into profile details associated with community members, send messages and recommendations within the community, automatically synchronize to other members' playlists, and otherwise interact directly within the community.

In one aspect, a profile contains various details about a member of the media community. A media card associated with a member's profile may be embedded in his or her portable media player and accessed by other members of the media community. Advantageously, the media card includes one or more actionable elements that enable interactions with the media community.

In another aspect, the invention awards media achievements to members of the media community as a function of their interactions with the media community. Components for establishing a media community membership, for interacting with the media community, and for awarding media achievements embody further aspects of the invention. Alternatively, embodiments of the invention may comprise various other methods and apparatuses.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is an exemplary block diagram illustrating a portable media player according to an embodiment of the invention.

FIG. 2 is an exemplary block diagram illustrating a media card for use with the media player of FIG. 1.

FIG. 3 is an exemplary block diagram illustrating a media community including the media player of FIG. 1.

FIG. 4 is an exemplary flow chart embodying aspects of the invention for creating the media card of FIG. 2 for a member of the media community.

FIG. 5 is an exemplary flow chart embodying further aspects of the invention for awarding a media achievement to a member of the media community.

FIG. 6 is a block diagram illustrating an exemplary computer-readable medium on which aspects of the invention may be stored.

Corresponding reference characters indicate corresponding parts throughout the drawings.

### DETAILED DESCRIPTION

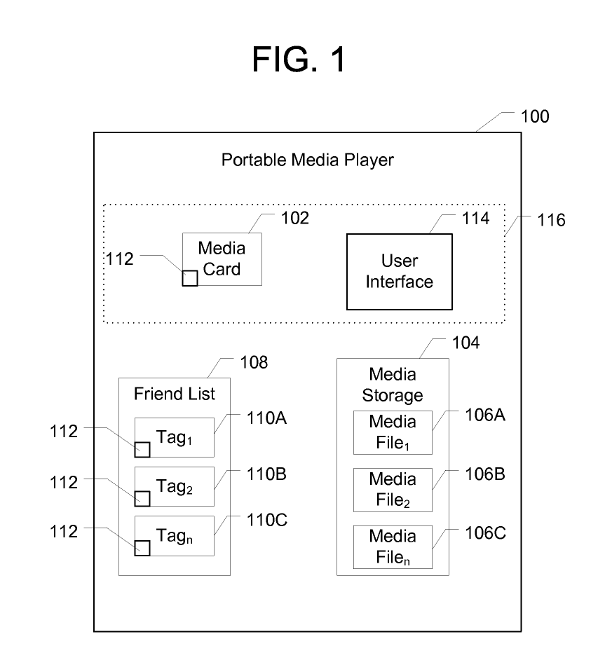

Referring now to the drawings, an embodiment of the invention includes a portable media player 100 illustrated in FIG. 1. The portable media player 100 is an electronic device capable of storing and playing files in one or more media formats. Such media players are often versatile, being able to load and play different formats of video, pictures, and recorded TV. Those skilled in the art are familiar with media player devices capable of rendering media content in various formats. Examples of media formats include: MPEG (Moving Picture Experts Group), DivX, XviD, MP3 (MPEG-1 Audio Layer 3), WAV (Waveform audio format), Ogg Vorbis, JPEG (Joint Photographic Experts Group), WMA (Windows Media Audio), WMV (Windows Media Video), ASF (Advanced Systems Format or Advanced Streaming Format) and GIF (Graphics Interchange Format). Portable media players, such as portable media player 100, may also include the ability to record video and audio. Additionally, some portable media players include card readers for removable media for data storage and transfer. Examples of removable media include: SD (Secure Digital) and MMC (MultiMediaCard). Portable media players may also store files other than multimedia files such as data files, computer programs, game files, word processing files, and text files.

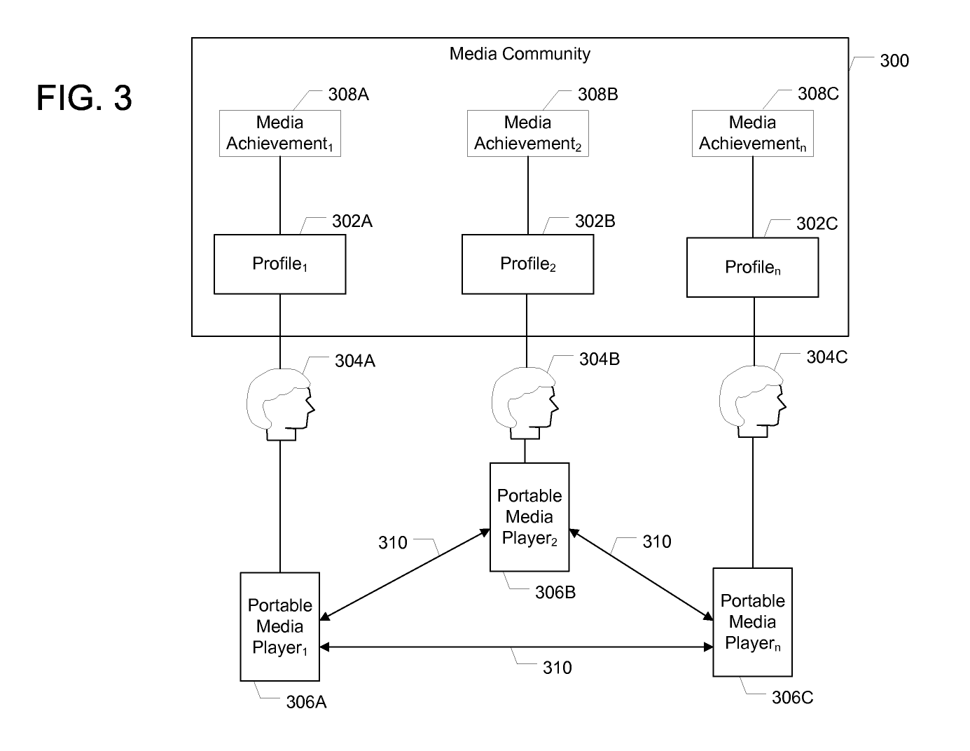

The portable media player 100 shown in FIG. 1 has a media card 102, a media storage area 104, and a friend list 108, all accessible to a user via a user interface 114. While embodiments of the invention are illustrated using the portable media player 100, it is contemplated that members of a media community can create the media card 102 and interact with the media community utilizing a variety of devices including, but not limited to, a PC client and other devices such as phones, gaming consoles, etc. According to aspects of the invention, a profile associated with a member of the media community 300 (see FIG. 3) contains various details about the member. According to aspects of the invention, the media card 102 is a visual representation of the profile including, for example, self-described and system derived identity information from the profile for use in interacting within the media community 300.

In one embodiment, the profile includes one or more of the following parameters: a tag (e.g., a nickname) of the member, a picture, a favorite genres of media, a media motto, a media strip, a member identifier, a time stamp of last profile change, a favorite media playlist, a most played tracks list, a media preference, a media achievement, a personal playlist, a compatibility indicator, a fan list, an achievement trophy case, a personal history of media consumption, a peer history, a media score of the member based on the media achievements of the member, a presence status (e.g., online, offline, away), mood of the member (e.g. happy, sad), a location of the user (e.g., home, school, work, at a club), events the member has attended or plans to attend, and a count of the number of times a detailed profile associated with the first tag has been viewed. The member has the ability to tune his or her privacy settings to control parameters of the profile from unwanted exposure to other members of media community 300. For example, user interface 114 presents the member with the option of showing one or more of the profile parameters to everyone, just friends, or no one. In an alternative embodiment, the member may select particular identifying information to be included in the media card 102.

The member's profile may be stored at a location associated with the media community 300 along with profiles of other community members. For example, media community 300 operates a server computer (not shown) accessible via a data communication network such as the Internet for storing and publishing the profiles. It is to be understood that the member may manage his or her profile via a personal computer, the portable media player 100, or other computing device connected via the network to the storage location associated with media community 300.

In addition to identifying information, media card 102 includes at least one actionable element 112 that allows the member to interact with the media community 300. In an embodiment, the media card 102 is an object embedded in a memory area 116 of the portable media player 100. Furthermore, the media card 102 may be embedded in a web page, email, phone, gaming console, and PC client. The memory area 116 of the portable media player 100 includes computer storage media in the form of removable and/or non-removable, volatile and/or nonvolatile memory.

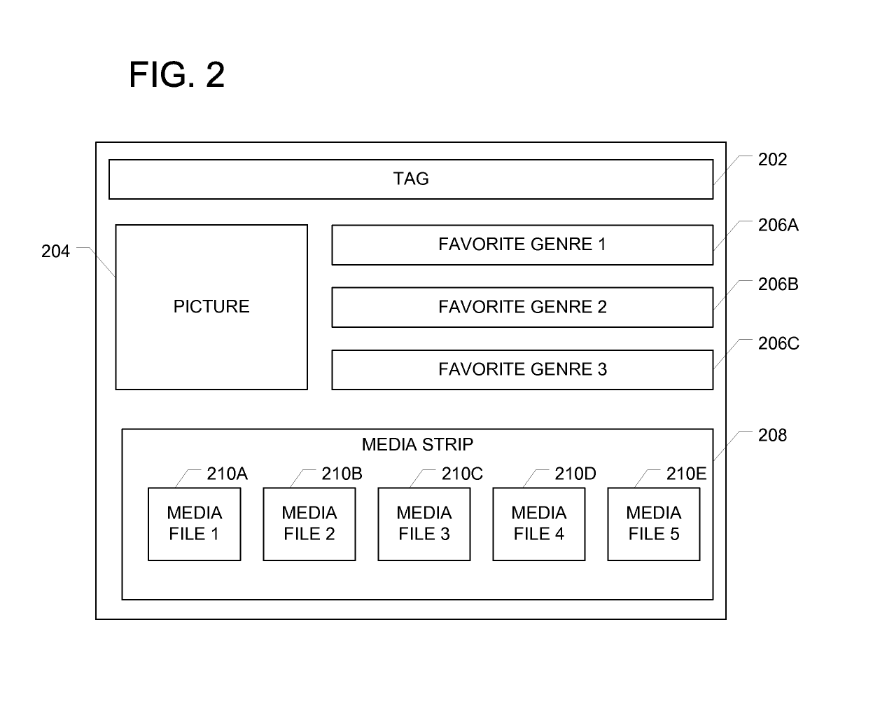

FIG. 2 illustrates an exemplary embodiment of the media card 102. In the illustrated embodiment, media card 102 includes a nickname or tag 202 and a picture 204 selected by the member. The tag 202 is a unique character name that represents the member within the media community 300 and is associated with the member's profile. Members of the media community can reference and search for other members of the community using the tag 202. Alternatively or additionally, the media card 102 includes a media motto, such as “Music is my life” or “Long live rock”.

According to aspects of the present invention, media card 102 enables media community members to access information relating to one or more favorite media genre elements 206A, 206B, 206C of the member. In one embodiment, the favorite genre elements 206A, 206B, 206C identify music genres such as country, pop, and alternative rock, etc. In another, the favorite genre elements 206A, 206B, 206C include movie genres such as action, drama, and comedy, etc. Alternatively, the favorite genre elements 206A, 206B, 206C include a mix of movie and music genres. In the media card 102, the three favorite genre elements 206A, 206B, 206C are not limiting in any way, and three are shown for illustrative purposes only. Any number of genres for various media types may be identified for the member in media card 102 without deviating from the scope of the present invention.

Referring further to FIG. 2, media card 102 also includes a media strip element 208. The media strip element comprises one or more references to a media file 210A, 210B, 210C, 210D, 210E. The media files 210A, 210B, 210C, 210D, 210E do not have to be stored in the media storage area 104 of the portable media player 100 of the member. The media files 210A, 210B, 210C, 210D, 210E of the of the media strip 208 may be designated by the member or populated as a function of the member's use of the portable media player 100. Alternatively, the media strip includes album covers or movie art that represent the references to the media files 210A, 210B, 210C, 210D, 210E of the of the media strip 208.

In one embodiment, the media strip 208 includes references to the favorite media files 210A, 210B, 210C, 210D, 210E of the member. In this case, the member designates his or her favorite media files 210A, 210B, 210C, 210D, 210E. In another embodiment, the media strip 208 includes the references to a top five list or the like. The references included in the list are the media files 210A, 210B, 210C, 210D, 210E most often rendered by the member on the portable media player 100. In this case, the portable media player 100 tracks the number of times a media file is rendered and automatically updates the top five list on a periodic basis (e.g., daily or weekly). In the media card 102, the five media files 210A, 210B, 210C, 210D, 210E are not limiting in any way, and five are shown for illustrative purposes only. Any number of references to media files 210A, 210B, 210C, 210D, 210E may be included in the media strip 208 without deviating from the scope of the present invention. Advantageously, the tag 202, favorite genres, media motto, and picture elements of media card 102 permit the member to anonymously interact with the media community 300 while maintaining a unique, individualized persona within the media community 300.

One or more of the elements of the media card 102 are actionable. In one embodiment, the actionable element 112 of the media card 102 enables one or more of the following: sending email to the member; sending a media recommendation to the member; sending an instant message to the member; rendering a media file associated with the member; transmitting a media file to the portable media player associated with the member; displaying the status of the member; and viewing a detailed profile of the member. In one embodiment, the picture 204, the tag 202 and media strip 208 are actionable elements. For example, if the picture 204 of the media card 102 is selected, a detailed profile of the member associated with the media card 102 is displayed on the portable media player 100. In another example, if the tag 202 of the media card 102 is selected, an electronic message or instant message is sent to the member associated with the media card 102. And in a third example, if the media strip 208 of the media card 102 is selected, the media files 210A, 210B, 210C, 210D, 210E of the media strip 208 are rendered on the portable media player 100. Advantageously, because one or more of elements of the media card 102 are actionable, the member can interact directly with the media community 300 via the portable media player 100, when the media player is connected to the network, without the need of a personal computing device.

Referring again to FIG. 1, the media storage area 104 provides a storage location for media files, such as media files 106A, 106B, 106C. In an embodiment, the media files 106A, 106B, 106C include music media files, video media files, and still image files. Alternatively, the media files 106A, 106B, 106C include game files and text files. The portable media player 100 includes the user interface 114 for rendering the media files 106A, 106B, A106C, for creating and managing playlists, for creating and managing the friend list 108, and for accessing the actionable elements of a media card 102. In an embodiment, the media files 106A, 106B, 106C are in one of the following formats: MPEG2 video, CD audio, MP3 audio, WMA audio and JPEG images.

By way of example and not limitation, media storage area 104 includes volatile and nonvolatile, removable and non-removable media implemented in any method or technology for storage of information such as computer readable instructions, data structures, program modules, media files 106A, 106B, 106C, or other data. For example, computer storage media include RAM, ROM, compact flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by portable media player 100.

As described above, the user interface 114 of portable media player 100 may display the friend list 108. In one embodiment, friend list 108 references one or more tags 110A, 110B, 110C of other members of the community. In an alternative embodiment, the friend list 108 references one or more media cards 102 of other members of the media community. By selecting the actionable element 112 of a tag 110A, 110B, 110C from the friend list, one member can directly interact with the other members of the media community 300 via the network. In one embodiment, the actionable element 112 of the media card 102 and tag 110A, 110B, 110C enables one or more of the following: sending email to the member; sending a media recommendation to the member; sending an instant message to the member; rendering a media file associated with the member; transmitting a media file to the portable media player 100 associated with the member; and viewing a detailed profile of the member. In an alternative embodiment, the actionable element 112 of the media card 102 and tag 110A, 10B, 110C displays the status of the associated member. This status information enables a first member to determine one or more of the following regarding a second member: whether the second member is currently using a second portable media player associated with the second member; whether the second member is logged into the media community; the time the second member last logged into the media community; and whether the second member is proximately located to the first member. Although three friend list tags are illustrated for convenience, it is to be understood that the number is merely illustrative and any number of additional tags may be added to the friend list 108 within the constraints of user interface 114. Moreover, one skilled in the art will appreciate that tags 110A, 110B, and 110C may have generally the same, or slightly different, construction as media card 102 without deviating from the scope of the invention.

FIG. 3 illustrates media community 300 according to an embodiment of the invention. The media community is comprised of one or more members referenced by profiles 302A, 302B, 302C. Each profile 302A, 302B, 302C corresponds to a member 304A, 304B, 304C and an associated portable media player 306A, 306B, 306C (i.e., profile₁ 302A is associated with member 304A and portable media player₁ 306A; profile₂ 302B is associated with member 304B and portable media player₂ 306B; and profileₙ 302C is associated with member 304C and portable media playerₙ 306C). In an embodiment, the portable media players 306A, 306B, 306C are configured similarly to the portable media players 100 illustrated in FIG. 1.

Additionally, a media achievement 308A,308B,308C may be associated with the profile 302A, 302B, 302C of the member 304A, 304B, 304C if certain conditions, defined by the media community, are met. The purpose of the media achievements 308A, 308B, 308C is to reward members 304A, 304B, 304C for their collections, accomplishments, and participation within the media community 300; encourage members 304A, 304B, 304C to collect media; to give members 304A, 304B, 304C a way to show-off and compare media; to provide conversation starters that bring members 304A, 304B, 304C together; to create greater enjoyment for media community members 304A304A, 304B, 304C; and to encourage members 304A, 304B, 304C to participate in the media community 300, and to generally promote social interaction.

The portable media players 306A, 306B, 306C illustrated in FIG. 3 may operate in a networked environment using logical connections 31 0. The logical connections 310 depicted in FIG. 3 include a local area network (LAN) and a wide area network (WAN), but may also include other networks. LAN and/or WAN may be a wired network, a wireless network (e.g. Wi-Fi, Bluetooth), a combination thereof, and so on. Such networking environments are commonplace in homes, schools, offices, hotels, restaurants, shops, cafes, businesses, enterprise-wide computer networks, intranets, and global computer networks (e.g., the Internet). The network connections shown are exemplary and other means of establishing a communications link between the computers may be used. In an alternative embodiment, the actionable element 112 of the media card 102 displays the status of the member. The status enables the members 304A, 304B, 304C to determine one or more of the following regarding the other members of the community: whether the member 304A, 304B, 304C is currently using his or her associated portable media player 306A, 306B, 306C; whether the member 304A, 304B, 304C is logged into the media community 300; the time the member 304A, 304B, 304C last logged into the media community 300; and whether the member 304A, 304B, 304C is proximately located to the another member. In an embodiment, members 304A, 304B, 304C are proximately located to each other if the portable media players 306A, 306B, 306C can directly establish communications via one or more logical connections 310 (e.g., in a peer-to-peer network).

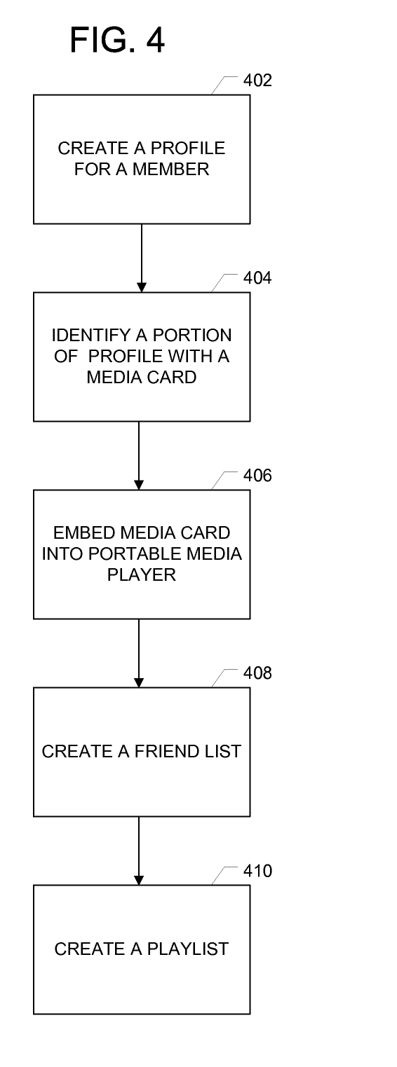

Referring now to FIG. 4, an exemplary flow chart illustrates aspects of the invention for creating the media card 102 for a member of the media community 300. At 402, the profile is created for the first member of the media community 300 using pre-defined fields. The first member is associated with the first portable media player 100 and the profile includes information describing various details about the first member, his or her usage of portable media player 100, and interactions within community 300. In an embodiment, the profile includes the parameters listed above.

At 404, the first media card 102 is created from the profile. In one embodiment, the first media card 102 includes an actionable element 112 that enables the first member to interact with the media community 300 via the first portable media player 100. In another embodiment, the first member designates the parameters of the profile included in the first media card 102. Proceeding to 406, the first media card 102 is provided to the first member. In one embodiment, the first media card 102 is an object that is embedded in the memory area 116 of the first portable media player 100. Appendix A contains an exemplary data definition for the first media card 102 according to an embodiment of the invention.

In one embodiment, at 408, the first member creates a friend list. The friend list comprises the media cards 102 of one or more other members of the media community 300. In a first alternative, the friend list comprises the tags 202 of one or more other members. In a second alternative, the friend list includes contacts from other communities, such as gaming communities and instant messaging communities. The first member interacts with the second member of the community via the actionable element 112 of a second media card 102 of the friend list; the second media card 102 is associated with the second member. In an embodiment, the interactions enabled by the actionable element 112 of the second media card 102 include: sending a message to the second member; sending a media recommendation to the second member; transferring media to the second member; and viewing the profile of the second member.

Alternatively, the media community 300 recommends a friend, i.e., the second member, to the first member. The first member may accept or reject a friend recommendation of the second member. The media community 300 recommends the second member to the first member as a function of one or more of the following: a compatibility index of first member; the awards or achievement earned by the first member; and other criteria from profile of first member. The compatibility index is a measure of “sameness” between the first member's media collection and other media community 300 members' media collection. Alternatively, the compatibility index may be generated as a function of first member's preferences, media achievements, or media collection. In an embodiment, the compatibility index is constantly updated as the first member interacts with other members of the media community 300 and the first portable media player 100.

In yet another embodiment, at 408, the first member creates a playlist. The playlist comprises a reference to a media file of the first portable media player 100. The playlist can be created by the first member or through the first member's interactions with the first portable media player 100. For example, in a favorite's playlist, the first member creates a playlist by designating his or her favorite all time media files. But in a top five (or ten, twenty, etc.) playlist, the playlist is automatically populated with the five most rendered media files of the first member for a periodic basis (e.g. daily, weekly, or all time). Furthermore, when a playlist is associated with the first media card 102, the playlist of the first media card 102 is automatically updated as the playlist is updated. For example, suppose on Monday the first member of the media community 300 adds the second media card 102 of the second member to his or her friend list and that a favorite's playlist of the second member is associated with the second media card 102. On Monday, the first member views the favorite's playlist of the second member and sees five songs, A, B, C, D, and E. On Tuesday, the second member deletes song C and adds song F to the favorite's playlist. If the first member views the favorite's playlist of the second media card 102 on Wednesday, the first member will see songs, A, B, D, E and F. In one embodiment, the playlist associated with the second media card 102 is updated when the first member syncs the first portable media player 100 with the media community 300. In another embodiment, the sync can occur via a personal computing device. Alternately, the first portable media player 100 can sync by directly connecting to a network associated with the media community 300.

In another embodiment, playlists enable the first member to interact with the media community 300 by publishing his or her playlists. Once the playlist has been published, other members of the media community 300 can view, download and rate the playlist. In alternative embodiment, the first member earns media achievements by publishing the playlist. Furthermore, the published playlist encourages other media community 300 interactions. For example, other members of the media community 300 may comment on playlist or contact the first member for more information about the media files of the playlist.

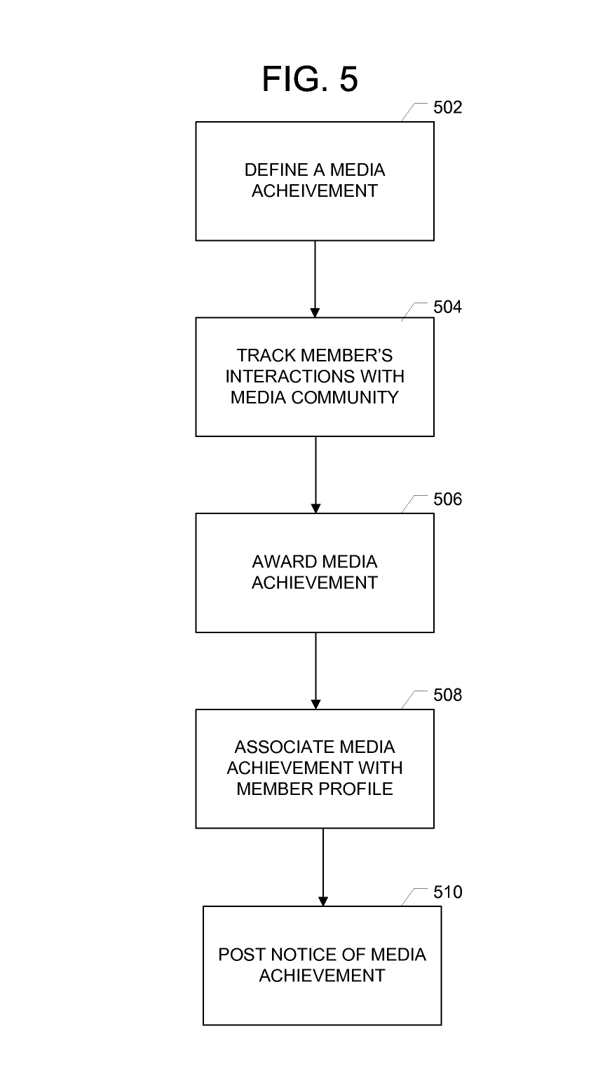

FIG. 5 is a flow diagram illustrating an embodiment of the invention for awarding a media achievement to the member of the media community 300. While embodiments of the invention are illustrated using the portable media player 100, it is contemplated that members of a media community can create the media card 102 and interact with the media community 300 utilizing a variety of devices including, but not limited to, a gaming console, a phone, and a PC. Media achievements reward members of the media community 300 for their media collections, media accomplishments, and participation within the media community 300. The media achievements also encourage members to collect media; give members a way to show-off and compare media; provide conversation starters that bring members together; create greater enjoyment for media community members; and encourage members to participate in the media community 300.

At 502, one or more media achievements are defined. In an embodiment, media achievements are awarded based on the following three categories: (1) contributing content to the media community (e.g., media, reviews, comments, testimonials, feedback, bugs, etc.); (2) purchasing content from the media community (e.g. music, movies, TV, specific genres, types, etc.); and (3) interacting with content in the media community (e.g., streaming, sharing, DJing, syncing, playing, mixing, etc.). The media achievements awarded by the media community 300 include one or more of the following: owning a portable media player 100 associated with the media community 300; converting a media library to a format compatible with the media community 300; recommending membership in the media community 300 to another person; authoring one or more media reviews; streaming media to another member of the community; sharing media with another member of the community; hosting a disc jockey session for other members of the media community 300; being a superfan; being a genre aficionado; rating media of the portable media device; being an audiophile; being a moviephile; being a music critic; being a movie critic; distributing media files using a syndication feed; and being a good media community 300 citizen. The media achievements according to an embodiment of the invention are listed and described in Appendix B.

At 504, the member's interactions with the media community 300 are tracked into the profile of the first member. At 506, the media achievement is award as a function of the member's interactions with the media community 300. In a first example, an Audiophile media achievement is awarded to a member who owns a minimum number of music media files. In another example, a member who owns or buys 50 songs is awarded a Music Hobbyist achievement; a member who owns or buys 100 songs is awarded a Music Enthusiasts; a member who owns or buys 250 songs is awarded a Audiophile achievement; and a member who owns or buys 500 songs is awarded a Music is my life achievement.

Dynamic Achievements are media achievements that are associated with a member's profile as long as he or she meets and maintains the criteria of the achievement. For example, suppose a Music Aficionado achievement is awarded to the member 304A, 304B, 304C in FIG. 3 who uses his or her portable media player 306A, 306B, 306C for a threshold period (e.g., at least four hours per day). If member 304A uses his portable media player 306A four hours a day, the Music Aficionado achievement 308A will be associated with his profile 302A. If the member 304A stops using his portable media player 306A four hours a day, the Music Aficionado achievement 308A will no longer be associated with his profile 302A.

Traveling Cup Achievements are media achievements 308A, 308B, 308C similar to a sporting event where the winner gets to own and display “the cup” until someone else defeats them. In one embodiment, the “cup” goes to the member 304A, 304B, 304C who has the longest listening time/viewing time per time period. Alternatively, the “cup” goes to the member 304A, 304B, 304C who owns the most media files. For example, suppose member 304B currently owns 120 media files, member 304B currently owns 150 media files, and member 304C currently owns 140 media files. The “cup” achievement for owning the most media files will be associated with the profile 302B of member 304B. Now suppose member 304C purchases 11 new media files bringing her total to 151 media files. The “cup” achievement for owning the most media files will no longer be associated with the profile 302B of member 304B and instead will be associated with the profile 302C of member 304C.

Referring further to FIG. 5, at 508, the media achievement is associated with the member's profile. In an alternative embodiment, the media achievement is included in the member's media card 102. In a third alternative, the media card 102 includes a trophy case. The member designates one or more media achievements awarded to the member to be included in the trophy case. This enables the member to showcase or highlight the media achievements that mean most to him or her. At 510, a notice of the media achievement is posted to the media community 300. The notice is accessible to the members of the media community 300 and includes information from the profile associated with the member

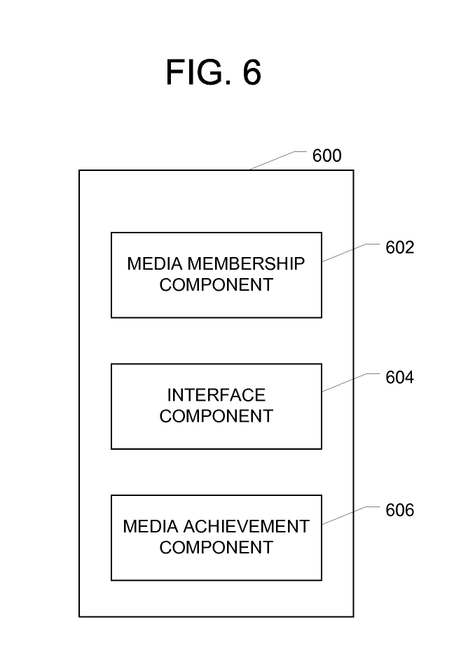

FIG. 6 illustrates computer-readable media 600 having computer-executable components for discovering people and media through media community 300 profiles. The components include a media membership component 602, an interface component 604, and a media achievement component 606. The portable media player 100 typically has at least some form of computer readable media. Computer readable media, which include both volatile and nonvolatile media, removable and non-removable media, may be any available medium that may be accessed by the portable media player 100. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, flash memory or other memory technology, CD-ROM, digital versatile disks (DVD) or other optical disk storage, magnetic disk storage or other magnetic storage devices, or any other medium that may be used to store the desired information and that may be accessed by the portable media player 100. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as Wi-Fi, acoustic, RF, infrared, and other wireless media, are examples of communication media. Combinations of any of the above are also included within the scope of computer readable media.

The media membership component 602 creates the profile of a member associated with the portable media player 100 in the media community 300. The media card 102 created from the profile and is an object that represents the self-described identity of the member. Furthermore, as described in detail above, the media card 102 includes one or more actionable elements which enable the member to interact with the media community 300. In an embodiment, the media card 102 is provided to the member associated with the profile and embedded in the memory area the portable media player 100.

The interface component 604 enables the member to access the actionable element 112 of a media card 102, to manage the friends list, and to create or share the playlist. The playlist references one of more media files of the portable media player 100 and is associated with the profile of the member. In an embodiment, the playlist is associated with at least one actionable element of the media card 102. For example, in the friend list, the first member associated with a portable player adds the tag 202 of a second member to his or her friend list. The second member has created a playlist and associated it with the tag 202. The actionable element of the tag 202 enables the first member to render the media files referenced in the playlist on the first portable media player 100.

In an alternative embodiment, the interface component is a drag and drop interface such that the first member selects and drags the media file of the first portable media player 100 to the tag 202 of the friend list or the first member selects and drags the tag 202 of the friend list to the media file of the first portable media player 100. In this case, the media file (or a reference to the media file) of the first portable media player 100 is transferred to the portable player associated with the second member associated with the tag 202.

The media achievement component 606 defines a media achievement associated with the member's interactions with the media community 300. The media achievement component 606 also tracks the member's interaction with the media community 300 into the profile associated with the member. Media achievements are awarded to the member as a function of the tracked interactions of the member. Once awarded, the media achievement is associated with the profile of the member. In an alternative embodiment, an actionable element of the media card 102 associated with the profile of the member is enabled to display the media achievements associated with the member.

For purposes of illustration, programs and other executable program components, such as the media membership component 602, the interface component 604, and the media achievement component 606, are illustrated herein as discrete blocks. It is recognized, however, that such programs and components reside at various times in different storage components of the portable media player 100, and are executed by the data processor(s) of the devices.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be addition0al elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

### Appendix A

Appendix B is a exemplary data definition for a media card according to an embodiment of the invention.

SOAP Definition Name: MediaPictureLarge
Type: Text
SOAP processing: A storage path is built to retrieve the picture. URL is path to (64×64).
SOAP API will determine the right public/private picture to reference, transparent to the client.
Example of data: //global/t:titleid/tile/0/imageid
Profile Definition Setting Name: XPROFILE_MEDIA_PICTURE
Data Type: UNICODE
Size (bytes): 100

SOAP Definition Name: MediaPictureSmall
Type: Text
SOAP processing: A storage path would be built to retrieve the picture. URL is path to (32×32). SOAP API will determine the right public/private picture to reference, transparent to the client.
Example of data: //global/t:titleid/tile/0/imageid
Profile Definition Setting Name: Part of the above setting
Data Type:
Size (bytes):

SOAP DefinitionName:
Type:
SOAP processing: Profile store keeps a private picture as well and the service does the mapping to keep this transparent to the client
Example of data:
Profile Definition Setting Name: XPROFILE_MEDIA_PICTURE_PRIVATE
Data Type: UNICODE
Size (bytes): 100

SOAP Definition Name: MediaStyle1
Type: DWORD
SOAP processing: None, but the top 3 bits encode the media type and an enum must be defined in the WSDL for the valid values. Enum: music=0; video=1; reserved=2-7
Example of data: 0x1000001C
Profile Definition Setting Name: XPROFILE_MEDIA_STYLE1
Data Type: DWORD
Size (bytes): 4

SOAP Definition Name: MediaStyle2
Type: DWORD
SOAP processing: None, but the top 3 bits encode the media type and an enum must be defined in the WSDL for the valid values. Enum: music=0; video=1; reserved=2-8
Example of data: 0x1000001C
Profile Definition Setting Name: XPROFILE_MEDIA_STYLE2
Data Type: DWORD
Size (bytes): 4

SOAP Definition Name: MediaStyle3
Type: DWORD
SOAP processing: None, but the top 3 bits encode the media type and an enum must be defined in the WSDL for the valid values. Enum: music=0; video=1; reserved=2-9
Example of data: 0x1000001C
Profile Definition Setting Name: XPROFILE_MEDIA_STYLE3
Data Type: DWORD
Size (bytes): 4

SOAP Definition Name: MediaStyleString1
Type: String
SOAP processing: string corresponding to mediastyle1
Example of data: Shoegaze
Profile Definition Setting Name: n/a
Data Type:
Size (bytes):

SOAP Definition Name: MediaStyleString2
Type: String
SOAP processing: string corresponding to mediastyle2
Example of data: Shoegaze
Profile Definition Setting Name: n/a
Data Type:
Size (bytes):

SOAP Definition Name: MediaStyleString3
Type: String
SOAP processing: string corresponding to mediastyle3
Example of data: Shoegaze
Profile Definition Setting Name: n/a
Data Type:
Size (bytes):

SOAP Definition Name: Top5Album1
Type: QWORD
SOAP processing: NONE
Example of data: 0x00000001ABCD1234
Profile Definition Setting Name: XPROFILE_TOP_ALBUM1
Data Type: QWORD
Size (bytes): 8

SOAP Definition Name: Top5Album2
Type: QWORD
SOAP processing: NONE
Example of data: 0x00000001ABCD1235
Profile Definition Setting Name: XPROFILE_TOP_ALBUM2
Data Type: QWORD
Size (bytes): 8

SOAP Definition Name: Top5Album3
Type: QWORD
SOAP processing: NONE
Example of data: 0x00000001ABCD1236
Profile Definition Setting Name: XPROFILE_TOP_ALBUM3
Data Type: QWORD
Size (bytes): 8

SOAP Definition Name: Top5Album4
Type: QWORD
SOAP processing: NONE
Example of data: 0x00000001ABCD1237
Profile Definition Setting Name: XPROFILE_TOP_ALBUM4
Data Type: QWORD
Size (bytes): 8

SOAP Definition Name: Top5Album5
Type: QWORD
SOAP processing: NONE
Example of data: 0x00000001ABCD1238
Profile Definition Setting Name: XPROFILE_TOP_ALBUM5
Data Type: QWORD
Size (bytes): 8

SOAP Definition Name: OfflineUserId
Type: Binary
SOAP processing: None. Format is binary DWORD of count of global user identifiers, followed by binary of those global user identifiers.
Example of data: 0x00000001abc2bfd467a949c78cc8dbd552dd2135
Profile Definition Setting Name: XPROFILE_OFFLINE_ID
Data Type: BINARY
Size (bytes): 52

SOAP Definition Name: SpecialtyAccountTypes
Type: Enum
SOAP processing: none
Example of data: 1
Profile Definition Setting Name: XPROFILE_BKGD_IMAGE
Data Type: DWORD
Size (bytes): 4

SOAP Definition Name: Media Motto
Type: Unicode
SOAP processing: NONE (128 characters)
Example of data: Mottos are for sissies
Profile Definition Setting Name: XPROFILE_MEDIA_MOTTO
Data Type: UNICODE
Size (bytes): 256

SOAP Definition Name: MembershipTier
Type: Uint
SOAP processing: NONE, enumerated as follows: 0=invalid, 3=silver, 6=gold
Example of data: 6
Profile Definition Setting Name: n/a
Data Type:
Size (bytes):

SOAP Definition Name: Timestamp
Type: DateTime
SOAP processing: Convert from UTC FILETIME to whatever SOAP date times are. Get C# DateTime via DateTime.GetFromFileTimeUtc(data). Timestamp should only be updated when the MusicTop20 or Top5AlbumX changes
Example of data: However SOAP represents dates and times.
Profile Definition Setting Name: XPROFILE_LAST_CHANGE_TIME
Data Type: DATETIME
Size (bytes): 8

SOAP Definition Name: MusicTop20
Type: Binary
SOAP processing: None. Format is binary QWORD of count of track identifiers, plus the tack identifiers which are also QWORDs. 21*8=168
Example of data:
0x0000000000000002AAAAAAAAAAAAAAAABBBBBBBBBBBBBBBB
Profile Definition Setting Name: XPROFILE_TOP_MUSIC
Data Type: BINARY

Size (bytes): 168

### Appendix B

Below is a list of media achievements that may be award to members of the media community.

Owner—member own a portable media player of the media community.

Vested Member of media community—Member has converted the media files of the portable media player to a format compatible with the media community.

Member has designated favorite genres.

Member has recommended another user of a portable media player to the media community.

Member wrote a first media review. Further awards for a 10th review, 50th review, 100+ reviews.

Streamer—Member has streamed a media file to another member of the media community.

Member has shared media with another member 50 times. Further awards for sharing 100 times and sharing 500+ times. In another example, the member has shared playlists. For example, a member who has shared 10 public playlists earns Playlist achievement; a member who has shared 25 public playlists earns DJ achievement; a member who has shared 50 public playlists earns Mix Master achievement; and a member who has shared 100+ public playlists earns a Mix Master dlux.

Another achievement is award based on the number of members who have downloaded a playlist of a member. For example, 100 people downloading your playlist earns a ‘People like my playlist’ achievement; 250 people downloading your playlist earns ‘My mixes shake it up’ achievement; 500 people downloading your playlist earns a ‘Yeah I'm a DJ’ achievement; 1000+ people downloading you playlist earns a ‘You can call me Mr. Mix Master Dlx’; and the most downloaded playlist earns a ‘Top Mix Dog’ achievement.

Member has hosted a DJ(Disc jockey) session. Further awards for DJing to 100 people and DJing to 500+ people.

A third media achievement relates to the rating of your playlists. For example, 100 people rating the playlist with a 75% approval earns a ½ star rating increase; 250 people rating the playlist with a 75% approval earns a 1 star rating increase; 500 people rating the playlist with a 80% approval earns a 1½ star rating increase; and 1000+ people rating the playlist with a 85% approval earns a 2 star rating increase.

Member has created a Personal Playlist.

Superfan—Member owns all of the media of an artist.

Genre Aficionado—Member owns a minimum number of media related to a genre (movie or music).

Member has rated his or her entire media collection.

Audiophile—Member owns a minimum number of music media files. For example, a member who owns or buys 50 songs is awarded a Music Hobbyist achievement; a member who owns or buys 100 songs is awarded a Music Enthusiasts; a member who owns or buys 250 songs is awarded a Audiophile achievement; and a member who owns or buys 500 songs is awarded a Music is my life achievement.

Moviephile—Member owns a minimum number of movies/TV media files. For example, a member who owns or buys 25 movies is awarded a Movie Hobbyist achievement; a member who owns or buys 50 movies is awarded a Movie Enthusiasts; a member who owns or buys 100 movies is awarded a Moviephile achievement; and a member who owns or buys 250 movies is awarded a Movies are my life achievement.

Music Critic—Member has written a minimum number of reviews of music media files.

Movie Critic—Member has written a minimum number of reviews of movie media files.

A minimum number of people have subscribed to member's internet broadcast (audio and/or video) of a media file using a syndication feed.

A good community citizen—A minimum number of people have purchased media that member has shared with them or because of a review member wrote.

Member has posted to a forum of the media community.

Member has watching/listened to a minimum number of hours of media files.

What is claimed is:

1. A method of sharing content among members of a media community, said method comprising:
creating a profile for a first member of the media community, said first member being associated with a first portable media player;
identifying at least a portion of the profile with a first media card, said first media card representing a self-described identity of the first member and including one or more actionable elements, said actionable elements enabling interactions with the media community; and
embedding the first media card in a memory area of the first portable media player, said memory area being accessible by one or more other members of the media community.

2. The method of claim 1, further comprising creating a friend list in the profile of the first member, said friend list including one or more entries associated with other members of the media community.

3. The method of claim 2, wherein at least one of the entries in the friend list comprises a second media card identifying at least a portion of a profile for a second member of the media community, said second media card including at least one of the actionable elements enabling interactions with the media community.

4. The method of claim 3, wherein the second media card is embedded in a memory area of a second portable media player associated with the second member, and further comprising automatically updating the second media card of the friend list in response to the profile for the second member being modified via the second portable media player.

5. The method of claim 2, wherein the profile for the first member includes a list of one or more media files, and further comprising:
receiving, via the first portable media player, a selection of at least one of the media files for sharing with a second member of the media community in the friend list; and
enabling a second portable media player associated with the second member to render the selected media file in response to the selection.

6. The method of claim 5, wherein the first portable media player has a drag and drop interface for receiving the selection of the media file for sharing and wherein the first member selects and drags the media file to the entry in the friend list for the second member or the first member selects and drags the entry in the friend list for the second member to the media file.

7. The method of claim 1, wherein the actionable element of the first media card enables one or more of the following: sending email to the first member; sending a media recommendation to the first member; sending an instant message to the first member; rendering a media file associated with the first member; transmitting a media file to the first portable media player associated the first member; and viewing a detailed profile of the first member.

8. The method of claim 1, further comprising:
creating a playlist, the playlist referencing one or more media files stored in the memory area of the first portable media player;
associating the playlist with the actionable element of the first media card of the profile for the first member; and
providing the first media card to a second member of the media community, said second member being associated with a second portable media player, wherein the actionable element of the provided first media card enables the second member to render the one or more media files referenced in the playlist on the second portable media player.

9. The method of claim 8, further comprising automatically updating the actionable element of the first media card provided to the second member in response to the first member modifying the playlist, the updated first media card enabling the second member to render the media file referenced in the modified playlist on the second portable media player.

10. The method of claim 8, wherein providing the first media card to the second member comprises embedding the first media card in one or more of the following: an email message and a web page.

11. The method of claim 1, wherein the profile includes one or more of the following: a tag of the member, a picture, a favorite genres of media, a media motto, a media strip, a member identifier, a time stamp of last profile change, a favorite media playlist, a most played tracks list, a media preference, a media achievement, a personal playlist, a compatibility indicator, a fan list, an achievement trophy case, a personal history of media consumption, a peer history, a media score of the member based on the media achievements of the user, a presence status, mood of the member, a location of the user, events the member has attended or plans to attend, and a count of the number of times a detailed profile associated with the first media card has been viewed.

12. The method of claim 1, wherein the first media card includes one or more of the following:
a tag of the member, a picture, a favorite genres of media, a media motto, a media strip, and a member identifier.

13. The method of claim 1, further comprising:
defining one or more media achievements associated with interactions among members of the media community;
tracking interactions of the first member with the media community in the profile of the first member;
awarding a media achievement to the first member as a function of the tracked interactions, said media achievement being associated with the profile of the first member.

14. A method for awarding a media achievement to members of a media community:
defining a media achievement associated with interactions within the media community;
tracking the interactions of a first member with the media community via a portable media player and recording the tracked interactions in a profile associated with said first member;
awarding the media achievement to the first member as a function of the tracked interactions of the first member; and
posting a notice of the awarded media achievement, said notice being accessible to the members of the media community, said notice including information from the profile associated with the first member.

15. The method of claim 14, wherein the media achievement comprises at least one of the following: owning a portable media player associated with the media community; converting a media library to a format compatible with the media community; recommending membership in the media community to another person; authoring one or more media reviews; streaming media to another member of the community; sharing media with another member of the community; hosting a disc jockey session for other members of the media community; being a superfan; being a genre aficionado; rating media of the portable media device; being an audiophile; being a moviephile; being a music critic; being a movie critic; distributing media files using a syndication feed; and being a good media community citizen.

16. The method of claim 14, wherein the media achievement includes a dynamic achievement, said dynamic achievement requiring the first member to maintain one or more criteria, said dynamic achievement being associated with the profile of the first member as long as the first member maintains the criteria of the media achievement.

17. A method of claim 14, further comprising:
identifying at least a portion of the profile with a first media card, said first media card representing a self-described identity of the first member and including one or more actionable elements, said actionable elements enabling interactions with the media community;
associating the awarded media achievement of the first member to the first media card; and
embedding the first media card in a memory area of the portable media player, said memory area being accessible by one or more other members of the media community.

18. The method of claim 17, further comprising recommending a friend to the first member of the media community as a function of the tracked interactions, said friend being associated with a second media card of a second member of the media community, and further comprising creating a friend list in the profile of the first member, said friend list including the second media card.

19. The method of claim 14, further comprising:
recommending a media file to the first member of the media community as a function of the tracked interactions; and
requesting the first member to add said media file to the portable media player.

20. A system for sharing content among members of a media community comprising: a media membership component for:
creating a profile for a first member of the media community, said first member being associated with a first portable media player, said profile representing a first member of the media community;
identifying at least a portion of the profile with a first media card, said first media card representing a self-described identity of the first member and including one or more actionable elements, said actionable elements enabling interactions with the media community; and
embedding the first media card in a memory area of the first portable media player, said memory area being accessible by one or more other members of the media community; a interface component for:
creating a playlist, the playlist referencing at least one media file stored in the memory area of the first portable media player;
associating the playlist with the actionable element of the first media cardof the profile for the first member; and
providing the first media card to a second member of the media community, said second member being associated with a second portable media player, wherein the actionable element of the provided first media card enables the second member to render the media file referenced in the playlist on the second portable media player; a media achievement component:
defining a media achievement associated with interactions within the media community;
tracking the interactions of the first member with the media community via the portable media player and recording said interactions in the profile of said first member;
awarding the media achievement to the first member as a function of the tracked interactions of the first member; and
associating the awarded media achievement of the first member to the first media card.
